(19) United States
(12) Patent Application Publication
(10) Pub. No.: US 2011/0307506 A1
(43) Pub. Date: Dec. 15, 2011

(54) METHOD AND APPARATUS FOR MANAGING CONTACTS

(75) Inventors: Jason Kass, Taunton, MA (US); Charles Bowden, Norristown, PA (US)

(73) Assignee: In4Med, Corporation, South Easton, MA (US)

(21) Appl. No.: 12/797,583

(22) Filed: Jun. 9, 2010

(51) Int. Cl. G06F 17/30; G06F 15/16

(52) U.S. Cl. 707/769; 709/219; 707/E17.014

(57) ABSTRACT

A computer-implemented method of an exhibitor interacting with a visitor and acquiring, managing, and qualifying leads, comprises: receiving identification information from the visitor at an input station; matching the identification information to a visitor account; and transmitting a notification of attendance by the visitor at the input station to a contact other than the visitor, defined for the visitor account by the exhibitor. The method may further comprise: collecting behavior information from the visitor defining one or more of type, quality and quantity of interactions between the visitor and the exhibitor, during the interactions; and updating records in a leads database linking the visitor account to the behavior information, while collecting the behavior information. The method may yet further comprise: computing lead qualification analytics as records in the leads database are updated; and updating records in the leads database linking the visitor account to computed lead qualification analytics, while computing lead qualification analytics. In another variation, the method may further comprise: providing substantially continuous, real-time leads database access to an exhibitor-designated contact other than the visitor. A system for an exhibitor interacting with a visitor and acquiring, managing, and qualifying leads, comprises: a first computer at an exhibitor site executing a visitor data collection client; a second computer remote from the exhibitor site executing a lead qualification database server, connected by a communications network to the first computer; and an exhibitor contact terminal connected to the communications network for access to the lead qualification database server of the second computer.

### BACKGROUND

The present invention relates to methods and apparatus applicable to various industries, government institutions, non-profit organizations, and individuals, for an entity acquiring, interacting with, and otherwise managing contacts, e.g. leads or other persons or articles of interest, that are identifiable and interact with various locations at which they are identified. Some embodiments relate to such methods and apparatus having computational capabilities to provide detailed analytics regarding such interactions, including inventory control and analysis based on used and requested inventory. Some embodiments relate to such methods and apparatus as used by exhibitors at trade shows and the like to interact with show attendees who might become sales leads for such exhibitors.

Current lead acquisition and management systems are exemplary of current systems in this field and include those in use at trade shows where exhibitors and attendees interact at a venue provided and administered by an organizer. The organizer, the exhibitors, and the attendees are not mutually exclusive, but rather roles depend on the interactions between the participants. Current lead acquisition and management systems also include systems in use at other locations at which leads are generated. Known systems scan an attendee's badge and produce a record of the attendee having performed that scan at a particular location, for example a particular exhibitor's booth or exhibit, but do not provide for any editing or updating of the information retrieved and stored in the record as a result of that scan. In some known systems, a limited set of questions are then presented, the answers to which are then added to the record of the lead. Leads are then returned to the exhibitor's either in the form of a printed receipt, or in the form of an electronic spread sheet file. In either case, the records presented include all visits for which a scan was performed, including all duplicate or repeated visits by a single visitor, but does not include any analysis of the quality of the leads contained in the records. Electronic spread sheets are conventionally delivered on a CD, on a USB flash drive, or using another portable, removable medium, on site, soon after the close of the event when the scanners are returned to the service desk. Electronic spread sheets are also conventionally delivered via email, or made available through the internet for download. Email or download delivery is conventionally not available immediately, and may be delayed for as long as 2 weeks subsequent to the close of the event at which the leads were generated.

### SUMMARY OF INVENTION

According to aspects of an embodiment, a computer-implemented method of an exhibitor interacting with a visitor and acquiring, managing, and qualifying leads, comprises: receiving identification information from the visitor at an input station; matching the identification information to a visitor account; and transmitting a notification of attendance by the visitor at the input station to a contact other than the visitor, defined for the visitor account by the exhibitor. According to some variations, the method may further comprise: collecting behavior information from the visitor defining one or more of type, quality and quantity of interactions between the visitor and the exhibitor, during the interactions; and updating records in a leads database linking the visitor account to the behavior information, while collecting the behavior information. According to some additional variations, the method may yet further comprise: computing lead qualification analytics as records in the leads database are updated; and updating records in the leads database linking the visitor account to computed lead qualification analytics, while computing lead qualification analytics. According to yet other variations, the method may further comprise: providing substantially continuous, real-time leads database access to an exhibitor-designated contact other than the visitor. According to yet other variations, the method may further comprise: computing virtual statistics on electronic documents requested during the interaction. Computed statistics may be sent via an electronic method and retrieved electronically at a later time are obtained, and may be added to the database. According to yet other variations, the method may further comprise: real-time inventory control of physical products being handed out, during an interaction. Physical inventory can be tracked and reported on to allow for restocking and planning.

According to aspects of another embodiment, a system for an exhibitor interacting with a visitor and acquiring, managing, and qualifying leads, comprises: a first computer at an exhibitor site executing a visitor data collection client; a second computer remote from the exhibitor site executing a lead qualification database server, connected by a communications network to the first computer; and an exhibitor contact terminal connected to the communications network for access to the lead qualification database server of the second computer.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a flow chart of an aspect for collecting visitor information at an exhibit according to some embodiments of the invention;

FIG. 2 is a flow chart of an aspect for personalizing a visitor's experience at an exhibit according to some embodiments of the invention;

FIG. 3 is a flow chart of an aspect for processing visitor information collected at least in part at an exhibit according to some embodiments of the invention;

FIG. 4 is a flow chart of an aspect for managing, retrieving and displaying information according to some embodiments of the invention; and

FIG. 5 is a flow chart of an aspect of embodiments including electronic document delivery.

### DETAILED DESCRIPTION

This invention is not limited in its application to the details of construction and the arrangement of components set forth in the following description or illustrated in the drawings. The invention is capable of other embodiments and of being practiced or of being carried out in various ways. Also, the phraseology and terminology used herein is for the purpose of description and should not be regarded as limiting. The use of “including,” “comprising,” or “having,” “containing”, “involving”, and variations thereof herein, is meant to encompass the items listed thereafter and equivalents thereof as well as additional items.

The invention will be explained in relation to certain examples in which aspects of embodiments may be used in connection with trade shows or exhibitions from which an exhibitor desires to collect information on attendees or visitors who might become sales prospects as a result of interactions at the show and elsewhere. Of course, other applications of aspects are possible, such as in settings where a business operates at multiple sites and lead information might be collected from those multiple sites. According to other examples, a retail location that provides educational stations or kiosks to both educate possible consumers, as well as to track their interests and habits could use the system to do so. Alternatively, corporate facilities where by similar stations are set up to educate current and potential customers or permit customers to place orders for services could use the system. According to yet other examples, a website which interacts with current and potential customers of a business and made publicly available could use the system. The system is not solely useful in profit-making business settings, either. Government institutions and non-profit organizations that desire to track and identify those individuals who they desire to target for a benefit, further interaction, or some other purpose, can use the system to track those individuals interaction with public information sources provided by those institutions and organizations, much as a business tracks leads interacting with their information sources or a show exhibitor tracks leads interacting with their booth kiosks.

Aspects of embodiments include collecting identification information from attendees at a trade show or exhibition when attendees visit the exhibits of individual exhibitors; updating and correcting the identification information; personalizing the experience of a visitor to an exhibit on the basis of their identity, their actions while interacting with the exhibit, and their selections made while interacting with the exhibit; providing immediate, real-time notification of visits to interested exhibitor contacts; providing real-time visitor experience feedback to interested exhibitor contacts; provide real-time delivery of relevant and/or requested literature to visitors; filtering, processing, and performing analytics on lead information by identity, account group, activity at an exhibit, literature requested, etc.; and, displaying or reporting analytics results in real-time to exhibitor contacts.

Aspects of embodiments can be implemented using Active Server Pages (ASP) code, the hypertext preprocessor language PHP, C++, Adobe Flash, or any other suitable programming or scripting language used on the World Wide Web and/or internet. Other aspects of embodiments can be implemented using any suitable web-enabled database, such as a Structured Query Language (SQL) database, including for example mySQL. Various aspects of embodiments are described as operating in real-time. In this context, “real-time” processing and/or communication is performed as soon as all necessary data is available or at an interval thereafter defined by need, but in any case where the system is used in connection with a discrete event such as a trade show, not later than the conclusion of the event at which data to be processed became available.

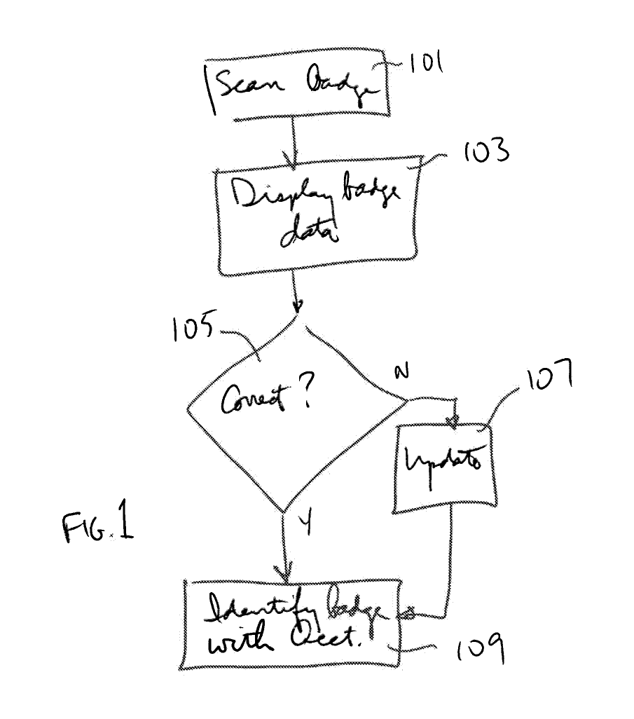

As shown in FIG. 1, information collected from attendees is later used to identify those attendees, individually. In some settings, pre-existing information about attendees or information collected prior to an event is pre-loaded into an account database from which it can be retrieved for various uses as described below. The account database may be stored on a networked computer connected to other computers and communication equipment via wired, optical, wireless or other connections, and located at the site of an event or remotely from the site of the event. In the setting of trade shows and exhibitions, information may have been collected during registration and pre-loaded into the account database; and, attendees carry ID badges with the information encoded thereon in machine readable formats. In other settings, other ID systems, such as customer loyalty cards, secure login via username and password combinations, or even manual entry, can be used. First, the badge is scanned (or optionally, information manually entered), step 101, for example at a welcome or informational kiosk. The kiosk may incorporate a networked computer and display connected to other computers and communication equipment via wired, optical, wireless or other connections. Next, the kiosk displays the ID information retrieved from the entry at step 101, step 103, to facilitate data checking and corrections. The ID information can be optionally displayed to either the visitor for self-correction or to booth personnel for independent review and correction. Alternatively, the user can perform self-correction at the time they pick up their badge, at some other time independent of booth visits, or at some other point in the booth visit when the user logs into the system. Such alternatives allow for a rapid environment version of the system in which the editing capabilities during booth visits are limited in scope, duration, or stage of the booth visit, or eliminated entirely, so as to speed the interaction at the booth. In any of these cases where editing is permitted, the reviewer determines whether the ID information is complete and correct, step 105. If the ID information is incomplete or incorrect, it is updated by the reviewer, step 107. Once it is complete and correct, the ID information is matched to an existing or new account record in the account database mentioned previously, as appropriate. Access is obtained to the account database either locally or remotely via the computer network, or by use of a locally accessible copy on the kiosk.

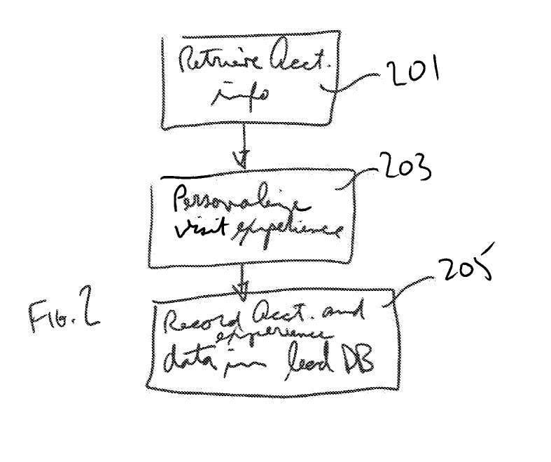

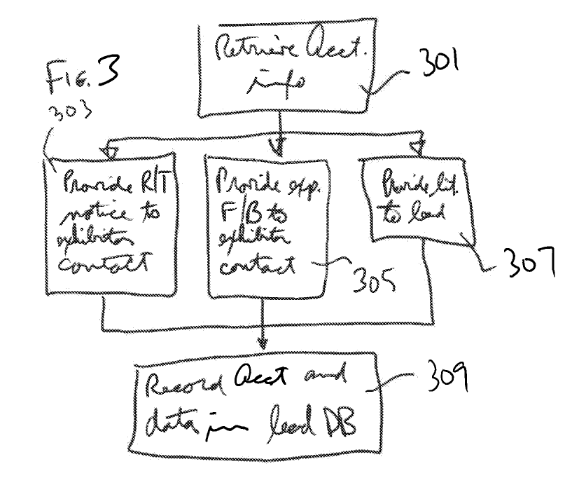

Each visitor can be presented with a customized experience at the booth based on the accumulated information connected to their account, as shown in FIG. 2. After the account has been identified (FIG. 1), additional account information is retrieved from the account database, or optionally from elsewhere, if available, step 201. Such additional information could be on file in the system, providing the system with a capability to import important pre-existing data obtained during prior interactions or provided by the exhibitor. As a result of retrieving that account information, portions of the visitor's experience controlled by kiosks at the exhibit booth can be customized, step 203, for example to present information on product lines in which the visitor has previously expressed interest first, followed by related new products and product lines. User interface and information filtering options selected previously by the visitor can be applied. Furthermore, as explained below, the personal relationship experience between the visitor and booth personnel or other contacts within the exhibitor's organization can be enhanced through back-channel communications (See FIG. 3 and discussion). Also, while the visitor interacts with the system, information about the visitor's preferences, activities, interests, and behavior within the system are either passively or interactively collected. Passive data collection might include a list of documents viewed and time spent on each document, total time spent interacting with the system, and a list of literature requested. Interactive information collected might include responses to questionnaires and opinion surveys, responses to requests for additional personally identifying information, and the like. Any other desired interest formation can be collected by any suitable means while the visitor interacts with the system.

Enhanced visitor experiences, improved lead management and relationship building, and improved lead identification and generation are achieved by aspects illustrated in FIG. 3. Upon retrieving the account information for a visitor, step 301, which may be done at the same time as the retrieval of account information referred to above in step 201, additional steps can be taken to enhance the visitor's experience and to improve the collection, management, and qualification of lead information. For example, the system can send a message via email, short message service (SMS) messaging system, or other messaging system, step 303, thus giving the contact the opportunity to engage in a personal interaction with the visitor by phone, email, or other communication system that may be available to them both. If the contact is elsewhere at the exhibition, or is in the booth, the contact can seek out and personally greet the visitor at the booth. Similarly, the system can send a message via email, SMS messaging system, or other messaging system containing visitor experiential information to a contact at the exhibitor's organization that has a need or desire to receive feedback regarding visitor experiences, so as to immediately act upon and improve those experiences, step 305, or for other desirable purposes. The system can also respond immediately to information requests with emails or other messages containing requested information, step 307. All of these interactions and activities, along with other useful data about these interactions and activities, such as time spent on each and results obtained are recorded in the visitor's account record so as to further quantify the type and quality of lead the visitor represents, step 309.

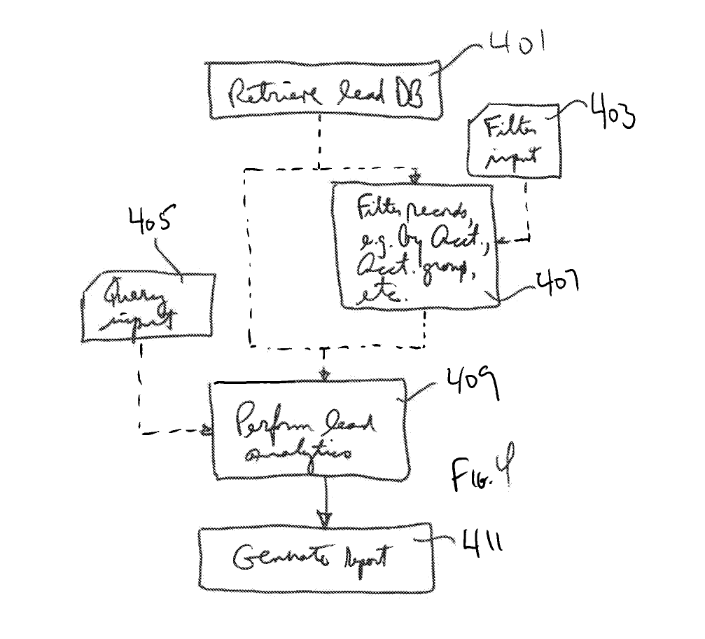

As shown in FIG. 4, the system provides real-time information to members of the exhibitor's organization useful for managing and pursuing leads. Access is obtained to the lead database, step 401, that has been built up from visitor ID information, visitor activity information, and other information related to the type and quality of each visitor as a potential lead, for example from steps 109, 205, and 309. The account database and lead database may be parts of a common database or entirely independent, they may include overlapping information or not, as desired. Inputs are received by which the lead database can be filtered, step 403, or by which the lead database can be queried, step 405. If a filter input, separate from a query input, is received, the records of the database are first filtered, step 407. If a query input is received, the query is run against the records of the lead database available after any filter has been applied, thus performing any desired lead qualification analytics, step 409. Querying and filtering can be performed in reverse order, but in many cases this will be less efficient. High quality leads may be indicated by product group interest, frequency of contact received from the visitor, type and duration of certain interactions by the visitor, etc. Some or all of these factors can be combined into a query seeking out desirable groups of lead records. A report is then generated and displayed or otherwise transmitted to the querying contact within the exhibitor's organization, step 411. Because the lead database is continuously updated as the visitors interact with the exhibitor's system, and because the lead database is continuously available to contacts within the exhibitor's organization, a continuous, real-time qualified lead report is available to all appropriate contacts within the exhibitor's organization. Such reports can be generated automatically once suitable filters and/or queries are set up. Automatically generated reports can then be transmitted automatically to the contact requesting them, as changes occur or periodically, providing real-time, qualified lead information.

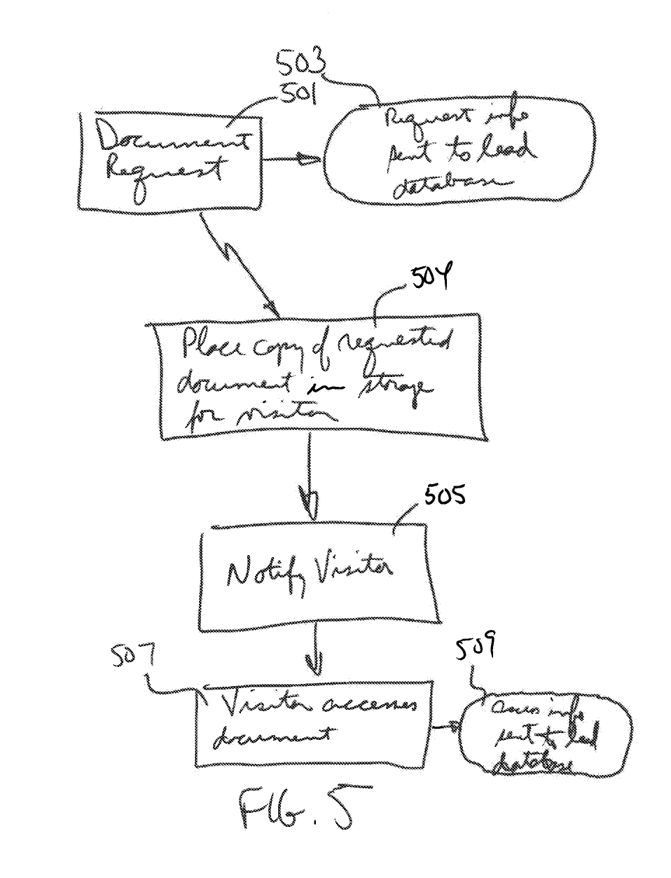

One advantageous form of interaction tracking is illustrated in FIG. 5. During an interaction, a visitor may request an electronic document, or may trigger a hidden request for an electronic document, step 501. An explicit request occurs when a visitor clicks a button or fills out a form, for example, whose known purpose from the visitor's point of view, is to obtain the electronic document. A hidden request may be triggered, for example, when a visitor views a certain depth of catalog information. Data concerning the request, in either case, is sent to the lead database for tracking, step 503. The electronic document requested is placed in a location on a computer network accessible to the visitor. Steps 501 and 503 may be repeated for additional requests and documents. Periodically, or on an event-triggered basis, a notification by email, SMS or other means is sent to the visitor which contains a user-specific address from which to retrieve the requested electronic document, step 505. The address may be single-use or multi-use. When the visitor secures the address to retrieve the electronic document, that event is detected and recorded in the leads database, step 507.

One advantageous use of the described lead database and account database, real-time data gathering and analysis, and real-time reporting capabilities is the exchange of certain useful data with existing customer relationship management (CRM) and other sales software tools and databases. For example, in the context of a trade show, an interaction that updates contact information for an account results in corresponding, real-time updates to CRM and/or other sales tools so that all interested users of those tools have the latest information. Similarly, analytical results generated by the lead database can be passed back to CRM and/or other sales tools so the interested members of the sales force can identify those prospects whose rating as a prospect have newly risen as a result of activity engaged in during the trade show. Data can be passed in and out of CRM and/or other sales tools through application programming interfaces (APIs), standard-formatted flat files such as tables of comma-separated values (CSVs), or any other suitable interface. Synchronization between the account database, including analytical results generated therefrom, and a CRM and/or other sales tools can be performed using any suitable continuous synchronization process, any suitable timed or polled synchronization process, or any manually-initiated, batch or targeted synchronization process.

The system illustrated above by way of one example can also be used in connection with point of purchase kiosks either at retail locations or in corporate environments. In place of a machine-readable badge, manual registration could be the primary method of capture of identity information. Such a system could be used to provide for follow up electronic and face-to-face meetings, based on criteria directly and indirectly collected during a window-shopping or sales interaction.

Such a system could also be tailored for use by trade show managers as well as exhibitors. In such a variation, the analytics obtained could be used by show managers who own and operate the event as a whole, to help gauge the health of the overall event. The analytics regarding lead quality could provide show managers with the ability to sell exhibit space on the basis of the overall computed quality of visitors attending the event.

According to another example, the system could provide inventory control in a variety of circumstances. The system can track the distribution of fulfillment materials requested and provide analytics related this, including when, where and to whom fulfillments were made, timeliness, current inventory stocks available, etc.

In yet another example, the system could help an employer track employees, such as when a particular employee is required to visit a number of predetermined locations. By fitting ID badges or other tokens associated with the employees with bar codes or radio frequency ID (RFID) tags, and using bar code scanners and RFID scanners, the system could report on the whereabouts of employees, or provide details on locations visited and times at which visits are made.

Any form of identification entered at or detected by a location could be used to provide tracking and analytics. Several applications of the system have been illustrated and suggested, but aspects of embodiments of the invention can extend beyond these illustrations.

Having thus described several aspects of at least one embodiment of this invention, it is to be appreciated various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed is:

1. A computer-implemented method of an entity managing contacts, comprising:
receiving identification information from the contact at an input station of the entity;
matching the identification information to a contact account; and
transmitting a notification of interaction between the contact and the input station to a person other than the contact, defined for the contact account by the entity.

2. The computer-implemented method of claim 1, wherein transmitting further comprises:
sending the notification in real-time.

3. The computer-implemented method of claim 1, further comprising:
collecting behavior information from the contact defining one or more of type, quality and quantity of interactions between the contact and the entity, during the interactions; and
updating records in a contacts database linking the contact account to the behavior information, while collecting the behavior information.

4. The computer-implemented method of claim 3, wherein collecting behavior information and updating records in a contacts database linking the contact account to the behavior information are performed in real-time.

5. The computer-implemented method of claim 3, wherein the contacts are potential leads, further comprising:
computing lead qualification analytics as records in the leads database are updated; and
updating records in the leads database linking the contact account to computed lead qualification analytics, while computing lead qualification analytics.

6. The computer-implemented method of claim 5, wherein computing lead qualification analytics and updating records in the leads database linking the contact account to computed lead qualification analytics are performed in real-time.

7. The computer-implemented method of claim 5, further comprising:
providing substantially continuous, real-time leads database access to an entity-designated person other than the contact.

8. The computer-implemented method of claim 3, further comprising:
continuously in real-time inventorying a quantity of physical hand-outs distributed during contact interactions.

9. The computer-implemented method of claim 8, further comprising:
tracking and reporting in real-time on the quantity of physical hand-outs in inventory whereby restocking and planning are facilitated.

10. The computer-implemented method of claim 3, further comprising:
requesting an electronic document, performed by the contact;
storing information about the requesting performed by the contact in the contacts database;
placing the electronic document in a storage location accessible through a computer network to the contact;
sending an electronic message to the contact notifying the contact that the electronic document is accessible at the storage location;
accessing the document at the storage location, performed by the contact; and
updating the contacts database to record the accessing performed by the contact.

11. A system for an entity interacting with a contact, comprising:
a first computer at a first site executing a contact data collection client;
a second computer remote from the first site executing a lead qualification database server, connected by a communications network to the first computer; and
a terminal inaccessible to the contact, connected to the communications network for access to the lead qualification database server of the second computer.
